(19) United States
(12) Patent Application Publication
(10) Pub. No.: US 2015/0085915 A1
(43) Pub. Date: Mar. 26, 2015

(54) Method and system for automatically encoding video with uniform throughput

(71) Applicants: Jay C.-C. Kuo, Arcadia, CA (US); Ping-kang Hsuing, Pacific Palisades, CA (US)

(72) Inventors: Jay C.-C. Kuo, Arcadia, CA (US); Ping-kang Hsuing, Pacific Palisades, CA (US)

(21) Appl. No.: 13/998,048

(22) Filed: Sep. 25, 2013

(51) Int. Cl. H04N 19/147; H04N 19/105; H04N 19/176; H04N 19/156

(52) U.S. Cl. CPC H04N 19/00175; H04N 19/00206; H04N 19/00024; H04N 19/00278
USPC 375/240.02

(57) ABSTRACT

A video compression method and system is specialized for uniform throughput video compression. The method/system encodes video sequences with uniform throughput, while reducing computational complexity as much as possible. By this means, it can efficiently decrease the latency incurred in video compression process and is suitable for real time video streaming and cloud gaming applications. The method is composed of two main modules: development of Basic Coding Unit (BCU) with the Intra Macroblock Allocation (IMA) map and reduction of computational complexity

### BACKGROUND

Cloud Gaming

Computer games have become one of the most dynamic and fastest changing technological areas. One approach to providing content rich games on mobile devices is to stream the 3D graphic contents as traditional video content (ordered sequences of individual still images). The idea is to define a client-server architecture where modern video streaming and cloud computing techniques are exploited to allow clients with thin computing and rendering resources to provide their users with interactive visualization of 3D environments and data sets.

There have been proposals for streaming 3D graphics commands and letting the client render the game contents, such as by Tzruya et al., in “Games@Large—a new platform for ubiquitous gaming and multimedia”, Proceedings of BBEurope, Geneva, Switzerland, December 2006, which is incorporated by reference as if set forth in full herein. However, the paradigm may change due to the emergence of cloud computing. The concept of cloud-based multi-player on-line gaming is to shift the graphic rendering operations from the local client to the server in the cloud center and stream the rendered game contents to end users in form of video. Such services have been offered by vendors such as Otoy and Onlive. The new service heavily relies on low-latency video streaming technologies. It demands rich interactivity between clients and servers and low delay video transmission from the server to the client. Many technical issues for such a system were discussed by Tzruya et al., discussed above, and also by A. Jurgelionis et al., in “Platform for Distributed 3D Gaming”, International Journal of Computer Games Technology”, 2009, the later of which is also incorporated by reference as if set forth in full herein. It remains needed, however, to develop highly efficient encoding schemes that generate a more uniform bit-rate throughput to avoid the buffer delay and network latency.

Video Compression, Generally

Conventional video compression methods are based on reducing the redundant and perceptually irrelevant information of video sequences (an ordered series of still images).

Redundancies can be removed such that the original video sequence can be recreated exactly (lossless compression). The redundancies can be categorized into three main classifications: spatial, temporal, and spectral redundancies. Spatial redundancy refers to the correlation among neighboring pixels. Temporal redundancy means that the same object or objects appear in the two or more different still images within the video sequence. Temporal redundancy is often described in terms of motion-compensation data. Spectral redundancy addresses the correlation among the different color components of the same image.

Usually, however, sufficient compression cannot be achieved simply by reducing or eliminating the redundancy in a video sequence. Thus, video encoders generally must also discard some non-redundant information. When doing this, the encoders take into account the properties of the human visual system and strive to discard information that is least important for the subjective quality of the image (i.e., perceptually irrelevant or less relevant information). As with reducing redundancies, discarding perceptually irrelevant information is also mainly performed with respect to spatial, temporal, and spectral information in the video sequence.

The reduction of redundancies and perceptually irrelevant information typically involves the creation of various compression parameters and coefficients. These often have their own redundancies and thus the size of the encoded bit stream can be reduced further by means of efficient lossless coding of these compression parameters and coefficients. The main technique is the use of variable-length codes.

Video compression methods typically differentiate images that can or cannot use temporal redundancy reduction. Compressed images that do not use temporal redundancy reduction methods are usually called INTRA or I-frames, whereas temporally predicted images are called INTER or P frames. In the INTER frame case, the predicted (motion-compensated) image is rarely sufficiently precise, and therefore a spatially compressed prediction error image is also associated with each INTER frame.

In video coding, there is always a trade-off between bit rate and quality. Some image sequences may be harder to compress than others due to rapid motion or complex texture, for example. In order to meet a constant bit-rate target, the video encoder controls the frame rate as well as the quality of images. The more difficult the image is to compress, the worse the image quality. If variable bit rate is allowed, the encoder can maintain a standard video quality, but the bit rate typically fluctuates greatly.

H.264/AVC (Advanced Video Coding) is a standard for video compression. The final drafting work on the first version of the standard was completed in May 2003 (Joint Video Team of ITU-T and ISO/IEC JTC 1, Draft ITU-T Recommendation and Final Draft International Standard of Joint Video Specification (ITU-T Rec. H.264|ISO/IEC 14496-10 AVC), Doc. JVT-G050, March 2003) and is incorporated by reference as if set forth in full herein. H.264/AVC was developed by the ITU-T Video Coding Experts Group (VCEG) together with the ISO/IEC Moving Picture Experts Group (MPEG). It was the product of a partnership effort known as the Joint Video Team (JVT). The ITU-T H.264 standard and the ISO/IEC MPEG-4 Part 10 (AVC) standard are jointly maintained so that they have identical technical content. H.264/AVC is used in such applications as players for Blu-ray Discs, videos from YouTube and the iTunes Store, web software such as the Adobe Flash Player and Microsoft Silverlight, broadcast services for DVB and SBTVD, direct-broadcast satellite television services, cable television services, and real-time videoconferencing.

The coding structure of H.264/AVC is depicted in FIG. 1, in which each coded picture is represented in block-shaped units of associated luma and chroma samples called macroblocks. The basic video sequence coding algorithm is a hybrid of inter-picture prediction to exploit temporal statistical dependencies and transform coding of the prediction residual to exploit spatial statistical dependencies. H.264 improves the rate distortion performance by exploiting advanced video coding technologies, such as variable block size motion estimation, multiple reference prediction, spatial prediction in intra coding, context based variable length coding (CAVLC), and context-based adaptive binary arithmetic coding (CABAC).

The H.264/AVC standard is actually more of a decoder standard than an encoder standard. This is because while H.264/AVC defines many different encoding techniques which may be combined together in a vast number of permutations and each technique having numerous customizations, an H.264/AVC encoder is not required to use any of them or use any particular customizations. Rather, the H.264/AVC standard specifies that an H.264/AVC decoder must be able to decode any compressed video that was compressed according to any of the H.264/AVC defined compression techniques.

Along these lines, H.264/AVC defines 17 sets of capabilities, which are referred to as profiles, targeting specific classes of applications. The Extended Profile (XP), intended as the streaming video profile, provides some additional tools to allow robust data transmission and server stream switching. Many of the available coding tools according to different profiles is shown in FIG. 2. In this work, we will focus on the adjustment of the H.264/AVC coding scheme so as to provide uniform throughput at the server end and optimize the encoder for the best performance in terms of the constant bit rate, error resilience, and compression efficiency.

### SUMMARY OF THE INVENTION

We use the H.264/AVC video coding standard as the basis and make numerous fine-tuning so that it can meet the stringent needs of the real-time on-line gaming requirement.

### BRIEF DESCRIPTION OF THE DRAWINGS

FIG. 1 is an architectural structure of standard video codecs.

FIG. 2 is a diagram of available coding tools in each profile of standard video codecs.

FIG. 3 illustrates various compression performances over frame types.

FIG. 4 is the distribution of resulting bitrates over frames.

FIG. 5 is an illustration of picture subdivision.

FIG. 6 is an illustration of various IMBA maps.

FIG. 7 is an illustration of the proposed BCU-based video coding scheme that generates a bit stream with a more uniform output bit rate.

FIG. 8 illustrates proposed Basic Coding Unit (BCU) based on Intra Macroblock Allocation Map (IMBA).

FIG. 9 is a flow chart of the proposed fast mode decision scheme.

FIG. 10 shows the experimental results of “War Craft” by Conventional GOP structure and proposed method.

FIG. 11 shows the experimental results of “Aion” by Conventional GOP structure and proposed method.

FIG. 12 shows the experimental results of “ShaoLinSi” by Conventional GOP structure and proposed method.

FIG. 13 shows the experimental results of “Blue Mars” by Conventional GOP structure and proposed method.

FIG. 14 shows the experimental results of “Sangoku 0” by Conventional GOP structure and proposed method.

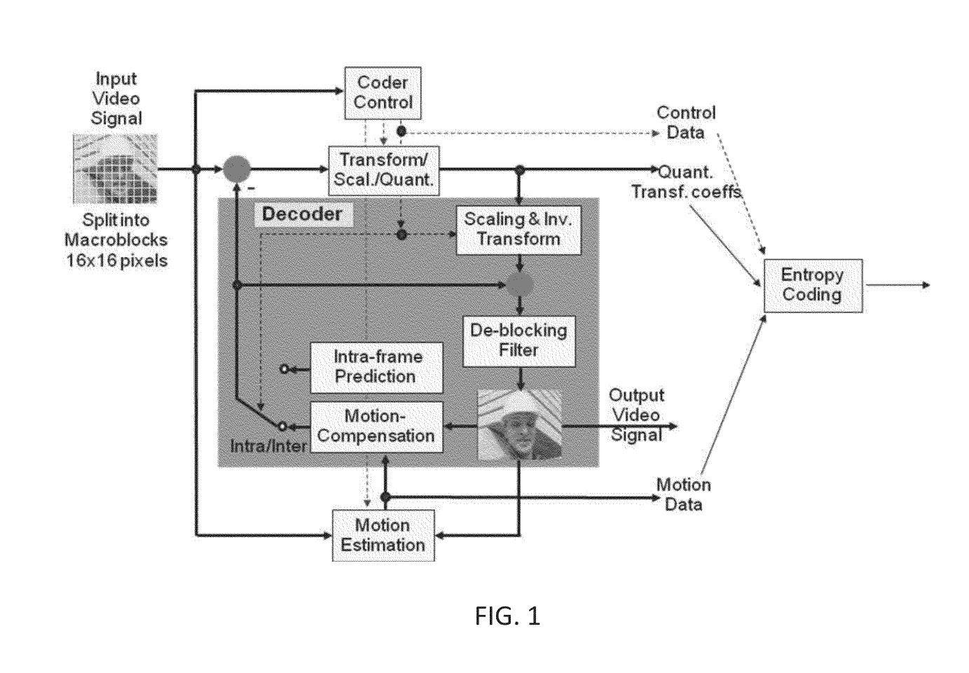

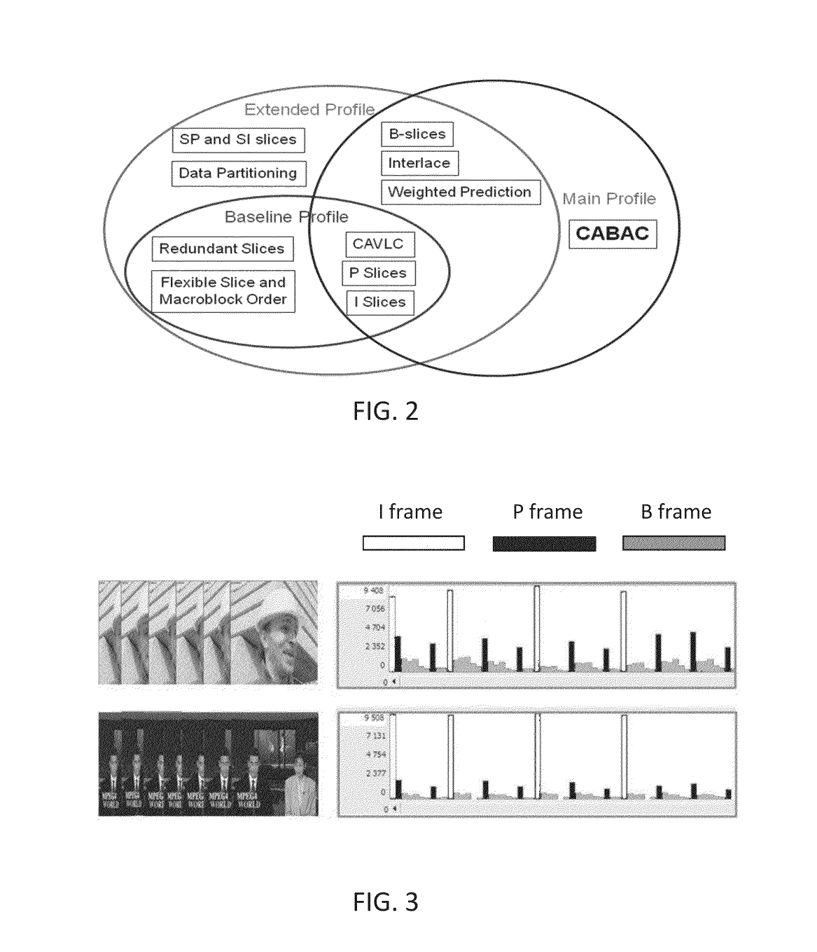

### DETAILED DESCRIPTION OF THE INVENTION

Characteristics of Game Contents

In the conventional H.264/AVC coding scheme, an intra frame (I frame) consumes a bit rate which is 5-10 times more as compared with that of an inter frame as shown in FIG. 3. However, the intra frame is more resilient to error propagation due to packet loss, so it is indispensible to employ the intra frame regularly in streaming video application.

To illustrate this phenomenon in the context of cloud gaming and to test embodiments of the methods and systems described herein, several test video sequences were selected. The gaming contents of the test video sequences were classified into four categories according to their usage as follows:
a) Two 3D games are tested: War Craft III (stand-alone edition) and Aion (on-line edition). For each segment, only the first frame is coded as I frame. The others are coded as P frames.
b) One flash game is tested: ShaoLinSiI. For each segment, only the first frame is coded as I frame. The others are coded as P frames.
c) One web game is tested: Sangoku. Its frame rate is 30 fps and there is one I frame in every 15 frames.
d) One 3D virtual environment is tested: BlueMars. Its frame rate is 30 fps and there is one I frame in every 15 frames.

To analyze the gaming contents, the test sequences were compressed using various quantization parameters (QP=12, 24, 36). The experimental results are summarized in Table 1 where “Compression Ratio” represents the ratio between compressed data size and uncompressed data size. Uncompressed data size is in YUV 4:2:0 format.

TABLE 1
Experimental results for gaming contents

| | | # of | | | | Average |
|---|---|---|---|---|---|---|
| Video | | coded | | | Compres- | Data Rate |
| Segments | Resolution | frames | Fps | QP | sion Ratio | (Kbps) |
| WarCraftIII | 800 × 600 | 154 | 30 | 12 | 1:11 | 1965 |
| | | | | 24 | 1:44 | 495 |
| | | | | 36 | 1:303 | 72 |
| Aion 0 | 1024 × 768 | 193 | 30 | 12 | 1:26 | 1381 |
| | | | | 24 | 1:103 | 343 |
| | | | | 36 | 1:833 | 43 |
| Aion 1 | 1024 × 768 | 158 | 30 | 12 | 1:20 | 1731 |
| | | | | 24 | 1:68 | 520 |
| | | | | 36 | 1:582 | 61 |
| ShaoLinSiII | 176 × 208 | 582 | 30 | 12 | 1:14 | 118 |
| | | | | 24 | 1:33 | 50 |
| | | | | 36 | 1:149 | 11 |
| ShuiPingZuo | 544 × 400 | 934 | 30 | 12 | 1:35 | 283 |
| | | | | 24 | 1:115 | 85 |
| | | | | 36 | 1:742 | 13 |
| YiGeRen | 544 × 400 | 1616 | 30 | 12 | 1:44 | 223 |
| | | | | 24 | 1:120 | 82 |
| | | | | 36 | 1:512 | 19 |
| Sangoku 1 | 1280 × 800 | 1497 | 50 | 12 | 1:326 | 236 |
| | | | | 24 | 1:559 | 137 |
| | | | | 36 | 1:1543 | 50 |
| BlueMars 0 | 1280 × 720 | 898 | 30 | 12 | 1:8 | 5524 |
| | | | | 24 | 1:29 | 1439 |
| | | | | 36 | 1:199 | 208 |

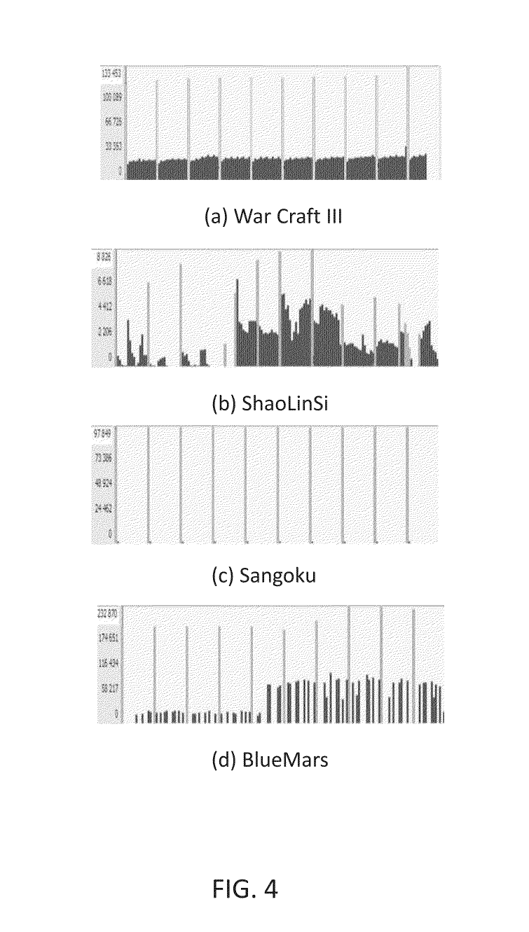

The graphs of bandwidth used over time for several of the video segments in Table 1 are shown in FIG. 4. As shown in FIG. 4, the distribution of resulting bitrates is content sensitive.

Comparing the above figures, we can see that the results are very content sensitive.

Overview

In many embodiments a new coding scheme is used that scatters the number of intra frame coding bits across multiple frames. Here, we propose ways to modify the video encoding algorithm for H.264/AVC so that it can offer a nearly constant-bit-rate output. It consists of three sub-tasks as follows:
1) Development of Basic Coding Unit (BCU) using the Intra Macroblock Allocation (IMA) map;
2) Bit allocation between frames;
3) Reduce computational complexity of video encoder.

In H.264, a picture is partitioned into fixed-size macroblocks that each covers a rectangular picture area of 16×16 samples of the luma component and 8×8 samples of each of the two chroma components. This partitioning into macroblocks has been adopted in all previous video coding standards, such as MPEG-4 Visual and H.263. Macroblocks (MB) are the basic building blocks of the standard for which the decoding process is specified. Hence, an MB is coded independently and each MB coding type (MB_type) can be determined while keeping the bit-stream compatible with the syntax of the standard H.264/AVC decoder.

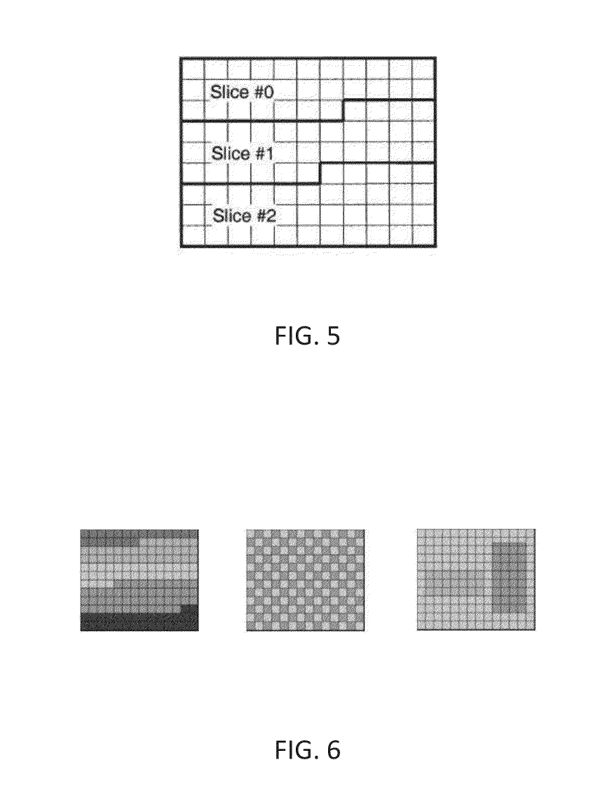

A slice is a sequence of macroblocks which are processed in the order of a raster scan, so a picture maybe split into one or several slices as shown in FIG. 5. A picture is therefore a collection of one or more slices in H.264/AVC. Slices are self-contained in the sense that given the active sequence and picture parameter sets, their syntax elements can be parsed from the bitstream and the values of the samples in the area of the picture that the slice represents can be correctly decoded without use of data from other slices provided that utilized reference pictures are identical at encoder and decoder.

Each slice can be coded using different coding types as follows.

I slice: A slice in which all MBs of the slice are coded using intra prediction.

P slice: In addition to the coding types of the I slice, some MBs of the P slice can also be coded using inter prediction with at most one motion-compensated prediction signal per prediction block.

B slice: In addition to the coding types available in a P slice, some MBs of the B slice can also be coded using inter prediction with two motion-compensated prediction signals per prediction block.

Since each slice of a coded picture should be decoded independently of the other slices of the picture, the H.264/AVC design enables sending and receiving the slices of the picture in any order relative to each other. So, any kinds of prediction methods, such as the motion estimation and intra prediction method cannot be used normally because additional information from out of the slice is not allowed. Hence, it is expected to lose coding performance as the number of slices increases. Under many typical circumstances, the coding performance degrades about 10% for each additional slice. In many embodiments of video encoders designed for achieving a more uniform bit rate, at least four slices for a given frame are used. So, in embodiments adding four slices, a coding performance degradation of about 40% is expected to provide the uniform bit rate video coding functionality.

Basic Coding Unit (BCU) with the Intra Macroblock Allocation (IMA) Map

Therefore, we propose a new type of coding unit called the basic coding unit (BCU). The BCU is similar to the concept of Slice as defined in the Extended Profile. Each macroblock can be assigned freely to a BCU based on a predefined IMBA map (Intra Macroblock Allocation map) shown in FIG. 6. The IMBA map consists of an identification number for each macroblock of the image that specifies to which basic unit group that macroblock belongs. However, the motion estimation and compensation process may not be limited within a BCU. Some BCU in a frame will be intra-coded while other BCUs will be inter-coded.

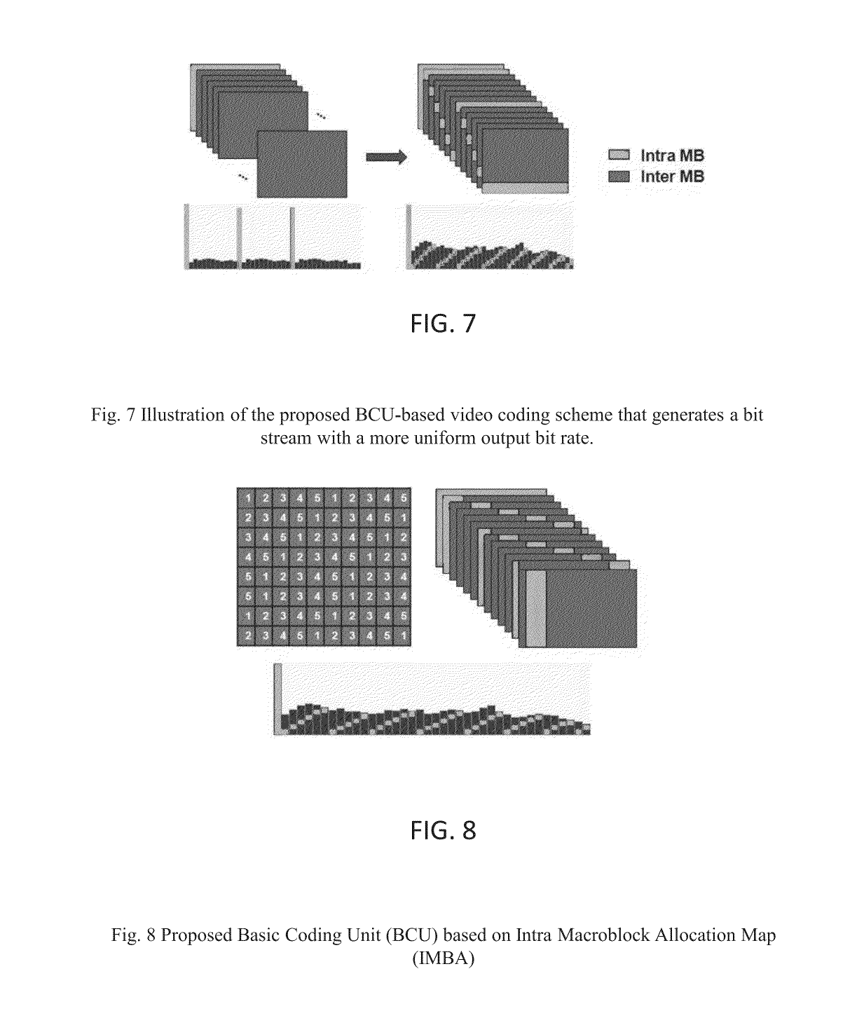

With this technique, we can provide a uniform output bit rate without losing any coding performance as depicted in FIG. 7, where the red BCU is intra-coded and the blue BCUs are inter-coded. The proposed scheme is also more robust to packet loss. If a basic unit is lost or corrupted during transmission, it will be easier to reconstruct lost blocks with the information of their neighboring blocks.

Bit Allocation between Frames

Now, we can allocate appropriate bit budgets over various frames in a video game based on the bandwidth requirement and the video content characteristics. Since each MB of a BCU can be encoded independently, different quantization parameters can be assigned to different MBs of a BCU to result in a bit stream that has a more uniform output bit rate at the encoder. For the first intra frame and scene change, we can also employ larger quantization parameter to minimize bit rate fluctuation. As shown in FIG. 8, we can assign appropriate quantization parameter to each IMBA map. In the figure, we have 5 IMBA maps.

Reduction of Computational Complexity

The H.264 standard achieves higher compression efficiency than previous video coding standards with the rate-distortion optimized (RDO) method for mode decision. The outstanding coding performance of H.264, however, comes with the cost of significantly higher complexity, making it too complex to be applied widely. Therefore, this research has focused on the computational complexity reduction for H.264 coding standard, making it feasible to perform real-time encoding on a personal computer. We propose a fast mode decision algorithm using early SKIP mode decision and combined motion estimation and mode decision.

Since H.264/AVC provides many coding options (or functions) to achieve the higher coding efficiency, we cannot use the all the coding options for real-time encoding software. Hence, select several efficient options need to be selected. To evaluate the encoding time of each option, the following calculation of time difference (ΔTime) is defined by

$$Δ Time = \frac{{T}_{Removed\_Option} - {T}_{Full\_Option}}{{T}_{Full\_Option}} \times 100 ( \% ) \qquad ( 1 )$$

where T_{Full}_{_{—}}_{Option} represents the total encoding time for using all options listed in Table 1. PSNR and bit-rate differences are calculated according to the numerical averages between the RD-curves derived from full option and the removed option, respectively. In TABLE 2, we represent the results for difference in PSNR and bitrates for each option. Using TABLE 2, we can estimate the efficiency of each coding option.

TABLE 2
DIFFERENCE IN PSNR AND BITRATE BETWEEN FULL OPTION
AND REMOVED OPTION (QP = 26, 28, 30, 36)

| | ΔPSNR | ΔBits | ΔTime |
|---|---|---|---|
| Removed Option | (dB) | (%) | (%) |
| Intra 16 × 16, 4 × 4 | −0.07 | 1.23 | −53.48 |
| Sub-pixel ME | −0.39 | 35.7 | −16.28 |
| Hadamard | −0.05 | −0.2 | −5.46 |
| Inter 16 × 8, 8 × 16 | −0.03 | 4.66 | −9.84 |
| Inter 8 × 8 | −0.03 | 0.94 | −1.1 |
| Inter 4 × 8, 8 × 4, 4 × 4 | −0.08 | 2.46 | −13.64 |

The SKIP mode refers to the 16×16 mode where neither motion nor residual information is encoded. It has the lowest complexity in the mode decision process since no motion search is required. Hence, if we determine the SKIP mode at an early stage, we can significantly reduce the encoding time by skipping the other inter modes. In order to determine whether the best MB mode is SKIP or not, we calculate rate-distortion cost for SKIP mode, K_{mode-nonzero} (SKIP), which represents the sum of absolute level of nonzero DCT coefficients. The value of J_{mode-nonzero} (SKIP) is calculated as following steps:
Step 1: Find the motion vector for SKIP mode
Step 2: Using the predicted motion vector in Step 1, get the difference MB between original MB and predicted MB
Step 3: Divide the difference MB into 4×4 blocks and each block is represented by its horizontal and vertical index pair (i,j) according to its position in the MB. (i,j=0, 1, 2, 3)
Step 4: Select eight blocks whose i and j are both odd indexes. After that, transform and quantize the eight blocks.
Step 5: Calculate J_{mode-nonzero} (SKIP) by adding the all the absolute value of nonzero quantized DCT coefficients in each block.

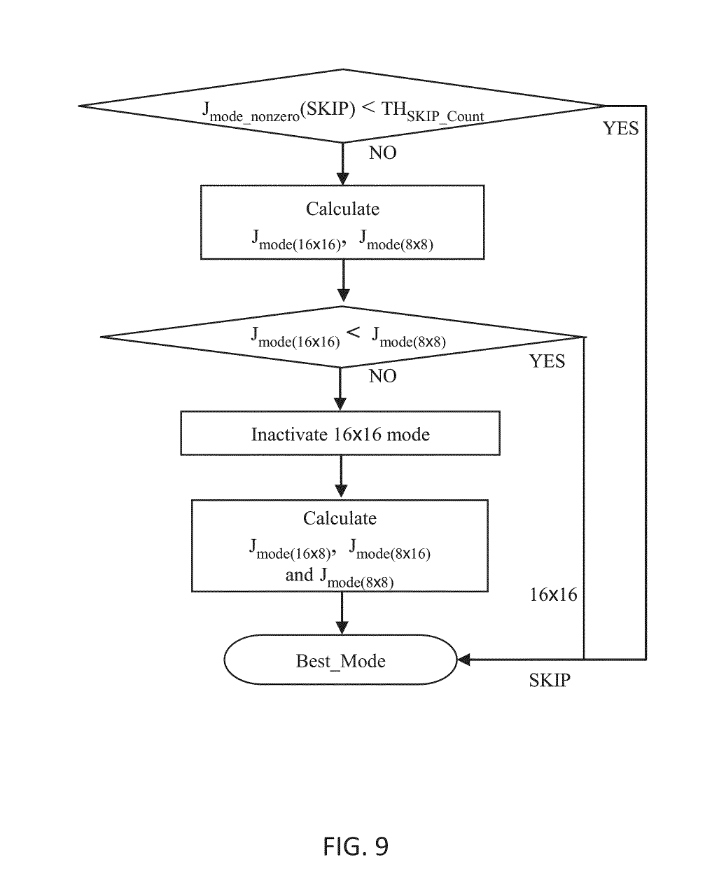

TH_{SKIP}_{_{—}}_{Count} represents threshold value for determining whether the best MB mode is SKIP or not. Using the early skip mode decision and an efficient mode comparison method, we propose an efficient fast mode decision algorithm shown in FIG. 9.

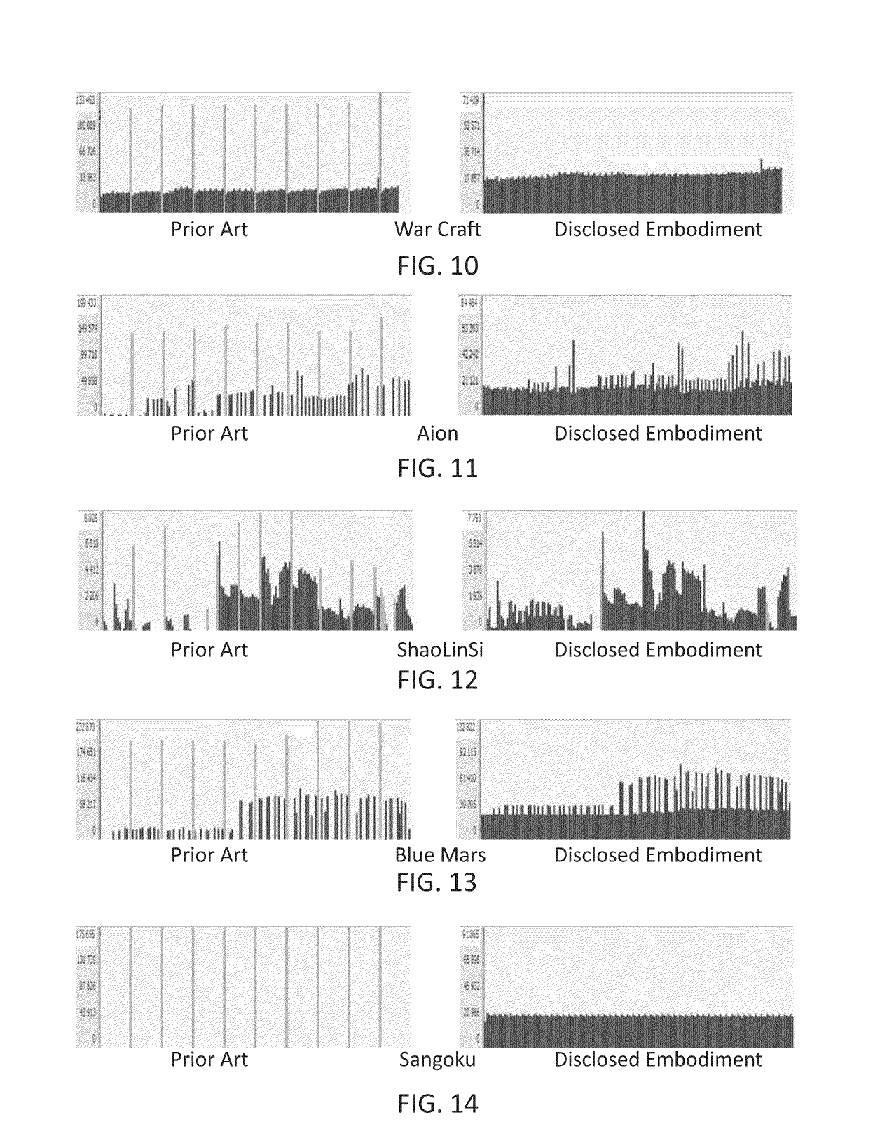

In order to show the efficiency of the developed uniform bitrates coding method, various gaming contents have been used in the experiments and the distribution of each bitstream has been compared in FIG. 10 to FIG. 14. In each of FIGS. 10 to 14, the bandwidth used for each frame using conventional GOP structure in shown in the left graph labeled “prior art” while the bandwidth used for each frame using an embodiment of the invention is shown in the right graph labeled “disclosed embodiment.”

What is claimed is:

1. A method for encoding a video sequence, the method specialized for encoding video of computer graphics games, the method comprising:
a scheme defining basic coding unit that is proposed as more flexible elements than conventional slices widely used in video coding;
an Intra Macroblock Allocation (IMA) map that is predefined as a guide on how to assign macroblocks among basic coding units;
a rate-distortion optimizer that allocates bits between frames; and
a computation load balancer that reduces the computational complexity, while maintaining a good visual quality of encoded video.
